(19) United States
(12) Patent Application Publication
(10) Pub. No.: US 2026/0300731 A1
(43) Pub. Date: Oct. 1, 2026

(54) Method, System, and Computer Program Product for Adjusting Neurons in a Neural Network

(71) Applicant: Visa International Service Association, San Francisco, CA (US)

(72) Inventor: Shivam Mohan, Lucknow (IN)

(21) Appl. No.: 19/089,822

(22) Filed: Mar. 25, 2025

(51) Int. Cl. G06N 3/082; G06F 17/16

(52) U.S. Cl. CPC G06N 3/082; G06F 17/16

(57) ABSTRACT

Methods, systems, and computer program products are provided for adjusting neurons in a neural network which include: identifying an output from an LLM including a neural network, each neuron thereof including a first weight; determining a subset of neurons that affected the generation of the output by: for each neuron, determining an activation value associated with generating the output; and determining the subset of neurons by determining the neurons having an activation value satisfying a threshold value; and adjusting neurons of the subset by updating the first weight of each neuron to a second weight.

### BACKGROUND

### Technical Field

This disclosure relates generally to neural networks and, in some non-limiting embodiments or aspects, to methods, systems, and computer program products for adjusting neurons in a neural network.

### Technical Considerations

Large language models (LLMs) are trained on large corpuses of data. Given the large amounts of data on which LLMs are trained, it is difficult to control the quality of data used to train an LLM. However, the data used to train the LLM plays an important role in what the model ultimately learns and what it generates as responses to prompts. One of the most difficult technical challenges that LLMs face is controlling the behavior of an LLM to prevent the LLM from generating responses with errors or to encourage the LLM to generate further quality responses.

One type of LLM is a neural network that comprises a plurality of neurons. When generating a response to a prompt, a subset of the plurality of neurons are activated to analyze the prompt and generate a suitable response.

### SUMMARY

Accordingly, provided are improved methods, systems, and computer program products for adjusting neurons in a neural network.

According to non-limiting embodiments or aspects, provided is a computer-implemented method for adjusting neurons in a neural network. The method may include identifying, with at least one processor, an output from a large language model (LLM), the LLM including a neural network including a plurality of neurons adjusted from training the LLM, each neuron of the plurality of neurons including a first weight; determining, with at least one processor, a subset of neurons from the plurality of neurons that affected the generation of the output by: for each neuron of the plurality of neurons, determining, with at least one processor, an activation value associated with generating the output; and determining the subset of neurons by determining the neurons from the plurality of neurons having an activation value satisfying a threshold value; and adjusting at least a portion of neurons of the subset of neurons of the LLM by updating the first weight of each neuron of the at least a portion of neurons to a second weight.

In some non-limiting embodiments or aspects, the method may further include: receiving, with at least one processor, a prompt from a user device; in response to receiving the prompt, generating, with the LLM, a response to the prompt using at least a portion of the adjusted at least a portion of neurons of the subset of neurons of the LLM.

In some non-limiting embodiments or aspects, the LLM may include a non-deterministic model.

In some non-limiting embodiments or aspects, the output may include an error, where the adjusting the at least a portion of neurons of the subset of neurons of the LLM may be executed in response to determining that the output includes the error.

In some non-limiting embodiments or aspects, the error may include a factually incorrect output.

In some non-limiting embodiments or aspects, determining that the output includes the error may include receiving feedback data from a user device to which the output was provided.

In some non-limiting embodiments or aspects, the second weight may include a non-zero weight.

In some non-limiting embodiments or aspects, none of the subset of neurons may be removed from the LLM.

In some non-limiting embodiments or aspects, adjusting the at least a portion of neurons of the subset of neurons of the LLM may include: generating a matrix including a plurality of first positions and a plurality of second positions, the plurality of first positions including ones, and the plurality of second positions including a value greater than 0 and less than 1, each of the plurality of first positions and the plurality of second positions corresponding to a neuron of the plurality of neurons of the LLM; and applying the matrix to the LLM to adjust the at least a portion of neurons of the subset of neurons of the LLM, where: a weight of each of the neurons having an activation value not satisfying the threshold value may be multiplied by a first position of the plurality of first positions of the matrix; and a weight of each of the neurons having an activation value satisfying the threshold value may be multiplied by a second position of the plurality of second positions of the matrix.

In some non-limiting embodiments or aspects, adjusting the at least a portion of neurons of the subset of neurons of the LLM may include: generating a matrix including a plurality of first positions and a plurality of second positions, the plurality of first positions including ones, and the plurality of second positions including a value greater than 1, each of the plurality of first positions and the plurality of second positions corresponding to a neuron of the plurality of neurons of the LLM; and applying the matrix to the LLM to adjust the at least a portion of neurons of the subset of neurons of the LLM, where: a weight of each of the neurons having an activation value not satisfying the threshold value may be multiplied by a first position of the plurality of first positions of the matrix; and a weight of each of the neurons having an activation value satisfying the threshold value may be multiplied by a second position of the plurality of second positions of the matrix.

According to non-limiting embodiments or aspects, provided is a system for adjusting neurons in a neural network. The system may include at least one processor configured to: identify an output from a large language model (LLM), the LLM including a neural network including a plurality of neurons adjusted from training the LLM, each neuron of the plurality of neurons including a first weight; determine a subset of neurons from the plurality of neurons that affected the generation of the output by: for each neuron of the plurality of neurons, determining an activation value associated with generating the output; and determining the subset of neurons by determining the neurons from the plurality of neurons having an activation value satisfying a threshold value; and adjust at least a portion of neurons of the subset of neurons of the LLM by updating the first weight of each neuron of the at least a portion of neurons to a second weight.

In some non-limiting embodiments or aspects, the at least one processor may be further configured to: receive a prompt from a user device; in response to receiving the prompt, generate, with the LLM, a response to the prompt using at least a portion of the adjusted at least a portion of neurons of the subset of neurons of the LLM.

In some non-limiting embodiments or aspects, the LLM may include a non-deterministic model.

In some non-limiting embodiments or aspects, the output may include an error, where the adjusting the at least a portion of neurons of the subset of neurons of the LLM may be executed in response to determining that the output includes the error.

In some non-limiting embodiments or aspects, the error may include a factually incorrect output.

In some non-limiting embodiments or aspects, determining that the output includes the error may include receiving feedback data from a user device to which the output was provided.

In some non-limiting embodiments or aspects, the second weight may include a non-zero weight.

In some non-limiting embodiments or aspects, none of the subset of neurons may be removed from the LLM.

In some non-limiting embodiments or aspects, adjusting the at least a portion of neurons of the subset of neurons of the LLM may include: generating a matrix including a plurality of first positions and a plurality of second positions, the plurality of first positions including ones, and the plurality of second positions including a value greater than 0 and less than 1, each of the plurality of first positions and the plurality of second positions corresponding to a neuron of the plurality of neurons of the LLM; and applying the matrix to the LLM to adjust the at least a portion of neurons of the subset of neurons of the LLM, where: a weight of each of the neurons having an activation value not satisfying the threshold value may be multiplied by a first position of the plurality of first positions of the matrix; and a weight of each of the neurons having an activation value satisfying the threshold value may be multiplied by a second position of the plurality of second positions of the matrix.

In some non-limiting embodiments or aspects, adjusting the at least a portion of neurons of the subset of neurons of the LLM may include: generating a matrix including a plurality of first positions and a plurality of second positions, the plurality of first positions including ones, and the plurality of second positions including a value greater than 1, each of the plurality of first positions and the plurality of second positions corresponding to a neuron of the plurality of neurons of the LLM; and applying the matrix to the LLM to adjust the at least a portion of neurons of the subset of neurons of the LLM, where: a weight of each of the neurons having an activation value not satisfying the threshold value may be multiplied by a first position of the plurality of first positions of the matrix; and a weight of each of the neurons having an activation value satisfying the threshold value may be multiplied by a second position of the plurality of second positions of the matrix.

According to non-limiting embodiments or aspects, provided is a computer program product for adjusting neurons in a neural network. The computer program product may include at least one non-transitory computer-readable medium including program instructions that, when executed by at least one processor, cause the at least one processor to: identify an output from a large language model (LLM), the LLM including a neural network including a plurality of neurons adjusted from training the LLM, each neuron of the plurality of neurons including a first weight; determine a subset of neurons from the plurality of neurons that affected the generation of the output by: for each neuron of the plurality of neurons, determining an activation value associated with generating the output; and determining the subset of neurons by determining the neurons from the plurality of neurons having an activation value satisfying a threshold value; and adjust at least a portion of neurons of the subset of neurons of the LLM by updating the first weight of each neuron of the at least a portion of neurons to a second weight.

In some non-limiting embodiments or aspects, the program instructions may be further configured to cause the at least one processor to: receive a prompt from a user device; in response to receiving the prompt, generate, with the LLM, a response to the prompt using at least a portion of the adjusted at least a portion of neurons of the subset of neurons of the LLM.

In some non-limiting embodiments or aspects, the LLM may include a non-deterministic model.

In some non-limiting embodiments or aspects, the output may include an error, where the adjusting the at least a portion of neurons of the subset of neurons of the LLM may be executed in response to determining that the output includes the error.

In some non-limiting embodiments or aspects, the error may include a factually incorrect output.

In some non-limiting embodiments or aspects, determining that the output includes the error may include receiving feedback data from a user device to which the output was provided.

In some non-limiting embodiments or aspects, the second weight may include a non-zero weight.

In some non-limiting embodiments or aspects, none of the subset of neurons may be removed from the LLM.

In some non-limiting embodiments or aspects, adjusting the at least a portion of neurons of the subset of neurons of the LLM may include: generating a matrix including a plurality of first positions and a plurality of second positions, the plurality of first positions including ones, and the plurality of second positions including a value greater than 0 and less than 1, each of the plurality of first positions and the plurality of second positions corresponding to a neuron of the plurality of neurons of the LLM; and applying the matrix to the LLM to adjust the at least a portion of neurons of the subset of neurons of the LLM, where: a weight of each of the neurons having an activation value not satisfying the threshold value may be multiplied by a first position of the plurality of first positions of the matrix; and a weight of each of the neurons having an activation value satisfying the threshold value may be multiplied by a second position of the plurality of second positions of the matrix.

In some non-limiting embodiments or aspects, adjusting the at least a portion of neurons of the subset of neurons of the LLM may include: generating a matrix including a plurality of first positions and a plurality of second positions, the plurality of first positions including ones, and the plurality of second positions including a value greater than 1, each of the plurality of first positions and the plurality of second positions corresponding to a neuron of the plurality of neurons of the LLM; and applying the matrix to the LLM to adjust the at least a portion of neurons of the subset of neurons of the LLM, where: a weight of each of the neurons having an activation value not satisfying the threshold value may be multiplied by a first position of the plurality of first positions of the matrix; and a weight of each of the neurons having an activation value satisfying the threshold value may be multiplied by a second position of the plurality of second positions of the matrix.

Further non-limiting embodiments or aspects are set forth in the following numbered clauses:

Clause 1: A computer-implemented method, comprising: identifying, with at least one processor, an output from a large language model (LLM), the LLM comprising a neural network comprising a plurality of neurons adjusted from training the LLM, each neuron of the plurality of neurons comprising a first weight; determining, with at least one processor, a subset of neurons from the plurality of neurons that affected the generation of the output by: for each neuron of the plurality of neurons, determining, with at least one processor, an activation value associated with generating the output; and determining the subset of neurons by determining the neurons from the plurality of neurons having an activation value satisfying a threshold value; and adjusting at least a portion of neurons of the subset of neurons of the LLM by updating the first weight of each neuron of the at least a portion of neurons to a second weight.

Clause 2: The computer-implemented method of clause 1, further comprising: receiving, with at least one processor, a prompt from a user device; in response to receiving the prompt, generating, with the LLM, a response to the prompt using at least a portion of the adjusted at least a portion of neurons of the subset of neurons of the LLM.

Clause 3: The computer-implemented method of clause 1 or 2, wherein the LLM comprises a non-deterministic model.

Clause 4: The computer-implemented method of any of clauses 1-3, wherein the output comprises an error, wherein the adjusting the at least a portion of neurons of the subset of neurons of the LLM is executed in response to determining that the output comprises the error.

Clause 5: The computer-implemented method of any of clauses 1-4, wherein the error comprises a factually incorrect output.

Clause 6: The computer-implemented method of any of clauses 1-5, wherein determining that the output comprises the error comprises receiving feedback data from a user device to which the output was provided.

Clause 7: The computer-implemented method of any of clauses 1-6, wherein the second weight comprises a non-zero weight.

Clause 8: The computer-implemented method of any of clauses 1-7, wherein none of the subset of neurons are removed from the LLM.

Clause 9: The computer-implemented method of any of clauses 1-8, wherein the adjusting the at least a portion of neurons of the subset of neurons of the LLM comprises: generating a matrix comprising a plurality of first positions and a plurality of second positions, the plurality of first positions comprising ones, and the plurality of second positions comprising a value greater than 0 and less than 1, each of the plurality of first positions and the plurality of second positions corresponding to a neuron of the plurality of neurons of the LLM; and applying the matrix to the LLM to adjust the at least a portion of neurons of the subset of neurons of the LLM, wherein: a weight of each of the neurons having an activation value not satisfying the threshold value is multiplied by a first position of the plurality of first positions of the matrix; and a weight of each of the neurons having an activation value satisfying the threshold value is multiplied by a second position of the plurality of second positions of the matrix.

Clause 10: The computer-implemented method of any of clauses 1-9, wherein the adjusting the at least a portion of neurons of the subset of neurons of the LLM comprises: generating a matrix comprising a plurality of first positions and a plurality of second positions, the plurality of first positions comprising ones, and the plurality of second positions comprising a value greater than 1, each of the plurality of first positions and the plurality of second positions corresponding to a neuron of the plurality of neurons of the LLM; and applying the matrix to the LLM to adjust the at least a portion of neurons of the subset of neurons of the LLM, wherein: a weight of each of the neurons having an activation value not satisfying the threshold value is multiplied by a first position of the plurality of first positions of the matrix; and a weight of each of the neurons having an activation value satisfying the threshold value is multiplied by a second position of the plurality of second positions of the matrix.

Clause 11: A system, comprising at least one processor configured to: identify an output from a large language model (LLM), the LLM comprising a neural network comprising a plurality of neurons adjusted from training the LLM, each neuron of the plurality of neurons comprising a first weight; determine a subset of neurons from the plurality of neurons that affected the generation of the output by: for each neuron of the plurality of neurons, determining an activation value associated with generating the output; and determining the subset of neurons by determining the neurons from the plurality of neurons having an activation value satisfying a threshold value; and adjust at least a portion of neurons of the subset of neurons of the LLM by updating the first weight of each neuron of the at least a portion of neurons to a second weight.

Clause 12: The system of clause 11, the at least one processor further configured to: receive a prompt from a user device; in response to receiving the prompt, generate, with the LLM, a response to the prompt using at least a portion of the adjusted at least a portion of neurons of the subset of neurons of the LLM.

Clause 13: The system of clause 11 or 12, wherein the LLM comprises a non-deterministic model.

Clause 14: The system of any of clauses 11-13, wherein the output comprises an error, wherein the adjusting the at least a portion of neurons of the subset of neurons of the LLM is executed in response to determining that the output comprises the error.

Clause 15: The system of any of clauses 11-14, wherein the error comprises a factually incorrect output.

Clause 16: The system of any of clauses 11-15, wherein determining that the output comprises the error comprises receiving feedback data from a user device to which the output was provided.

Clause 17: The system of any of clauses 11-16, wherein the second weight comprises a non-zero weight.

Clause 18: The system of any of clauses 11-17, wherein none of the subset of neurons are removed from the LLM.

Clause 19: The system of any of clauses 11-18, wherein the adjusting the at least a portion of neurons of the subset of neurons of the LLM comprises: generating a matrix comprising a plurality of first positions and a plurality of second positions, the plurality of first positions comprising ones, and the plurality of second positions comprising a value greater than 0 and less than 1, each of the plurality of first positions and the plurality of second positions corresponding to a neuron of the plurality of neurons of the LLM; and applying the matrix to the LLM to adjust the at least a portion of neurons of the subset of neurons of the LLM, wherein: a weight of each of the neurons having an activation value not satisfying the threshold value is multiplied by a first position of the plurality of first positions of the matrix; and a weight of each of the neurons having an activation value satisfying the threshold value is multiplied by a second position of the plurality of second positions of the matrix.

Clause 20: The system of any of clauses 11-19, wherein the adjusting the at least a portion of neurons of the subset of neurons of the LLM comprises: generating a matrix comprising a plurality of first positions and a plurality of second positions, the plurality of first positions comprising ones, and the plurality of second positions comprising a value greater than 1, each of the plurality of first positions and the plurality of second positions corresponding to a neuron of the plurality of neurons of the LLM; and applying the matrix to the LLM to adjust the at least a portion of neurons of the subset of neurons of the LLM, wherein: a weight of each of the neurons having an activation value not satisfying the threshold value is multiplied by a first position of the plurality of first positions of the matrix; and a weight of each of the neurons having an activation value satisfying the threshold value is multiplied by a second position of the plurality of second positions of the matrix.

Clause 21: A computer program product comprising at least one non-transitory computer-readable medium including program instructions that, when executed by at least one processor, cause the at least one processor to: identify an output from a large language model (LLM), the LLM comprising a neural network comprising a plurality of neurons adjusted from training the LLM, each neuron of the plurality of neurons comprising a first weight; determine a subset of neurons from the plurality of neurons that affected the generation of the output by: for each neuron of the plurality of neurons, determining an activation value associated with generating the output; and determining the subset of neurons by determining the neurons from the plurality of neurons having an activation value satisfying a threshold value; and adjust at least a portion of neurons of the subset of neurons of the LLM by updating the first weight of each neuron of the at least a portion of neurons to a second weight.

Clause 22: The computer program product of clause 21, the program instructions further configured to cause the at least one processor to: receive a prompt from a user device; in response to receiving the prompt, generate, with the LLM, a response to the prompt using at least a portion of the adjusted at least a portion of neurons of the subset of neurons of the LLM.

Clause 23: The computer program product of clause 21 or 22, wherein the LLM comprises a non-deterministic model.

Clause 24: The computer program product of any of clauses 21-23, wherein the output comprises an error, wherein the adjusting the at least a portion of neurons of the subset of neurons of the LLM is executed in response to determining that the output comprises the error.

Clause 25: The computer program product of any of clauses 21-24, wherein the error comprises a factually incorrect output.

Clause 26: The computer program product of any of clauses 21-25, wherein determining that the output comprises the error comprises receiving feedback data from a user device to which the output was provided.

Clause 27: The computer program product of any of clauses 21-26, wherein the second weight comprises a non-zero weight.

Clause 28: The computer program product of any of clauses 21-27, wherein none of the subset of neurons are removed from the LLM.

Clause 29: The computer program product of any of clauses 21-28, wherein the adjusting the at least a portion of neurons of the subset of neurons of the LLM comprises: generating a matrix comprising a plurality of first positions and a plurality of second positions, the plurality of first positions comprising ones, and the plurality of second positions comprising a value greater than 0 and less than 1, each of the plurality of first positions and the plurality of second positions corresponding to a neuron of the plurality of neurons of the LLM; and applying the matrix to the LLM to adjust the at least a portion of neurons of the subset of neurons of the LLM, wherein: a weight of each of the neurons having an activation value not satisfying the threshold value is multiplied by a first position of the plurality of first positions of the matrix; and a weight of each of the neurons having an activation value satisfying the threshold value is multiplied by a second position of the plurality of second positions of the matrix.

Clause 30: The computer program product of any of clauses 21-29, wherein the adjusting the at least a portion of neurons of the subset of neurons of the LLM comprises: generating a matrix comprising a plurality of first positions and a plurality of second positions, the plurality of first positions comprising ones, and the plurality of second positions comprising a value greater than 1, each of the plurality of first positions and the plurality of second positions corresponding to a neuron of the plurality of neurons of the LLM; and applying the matrix to the LLM to adjust the at least a portion of neurons of the subset of neurons of the LLM, wherein: a weight of each of the neurons having an activation value not satisfying the threshold value is multiplied by a first position of the plurality of first positions of the matrix; and a weight of each of the neurons having an activation value satisfying the threshold value is multiplied by a second position of the plurality of second positions of the matrix.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for adjusting neurons in a neural network, according to some non-limiting embodiments or aspects;

FIG. 2 is a schematic diagram of an LLM-generated response, according to some non-limiting embodiments or aspects;

FIGS. 3A-3B are schematic diagrams of feedback data, according to some non-limiting embodiments or aspects;

FIG. 4 is a schematic diagram of a neural network having a plurality of paths, according to some non-limiting embodiments or aspects;

FIGS. 5A-5C are schematic diagrams of a neural network having a plurality of paths and activation values, according to some non-limiting embodiments or aspects;

FIG. 6 is a schematic diagram of a matrix to be applied to a neural network to adjust neurons thereof, according to some non-limiting embodiments or aspects;

FIG. 7 is a flow diagram for an example process for adjusting neurons in a neural network, according to some non-limiting embodiments or aspects;

FIG. 8 is a schematic diagram of an example electronic payment processing network, according to some non-limiting embodiments or aspects; and

FIG. 9 is a schematic diagram of example components of one or more devices of FIG. 1, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the terms “client” and “client device” may refer to one or more client-side devices or systems. As an example, a “client device” may refer to one or more computing devices. In some non-limiting embodiments or aspects, a client device may be an electronic device configured to communicate with one or more networks. For example, a client device may include one or more computers, portable computers, laptop computers, tablet computers, mobile devices, cellular phones, wearable devices (e.g., watches, glasses, lenses, clothing, and/or the like), personal digital assistants (PDAs), and/or the like.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a PDA, and/or other like devices. A computing device may also be a desktop computer or other form of non-mobile computer.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a payment device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers configured to process online payment transactions through webpages, mobile applications, and/or the like.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices and/or components of such (e.g., processors, servers, client devices, software applications, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to methods, systems, and computer program products for adjusting neurons in a neural network. The neurons may be adjusted in response to the model generating an output comprising an error or in response to an output comprising a quality response. For example, non-limiting embodiments or aspects may decompose traits of the neural network by determining which neurons thereof fired, which may be the neurons that affected the output generated by the model. Determining the neurons that affected the output may include determining an activation metric for each neuron in the neural network. Determining the neurons that affected the output may further include determining the neurons in the neural network having an activation value that satisfies a threshold. The neurons having an activation value that satisfies a threshold may represent the neurons that fired in the generation of the output.

Non-limiting embodiments or aspects may adjust at least a portion of the neurons that affected the response. Adjusting those neurons may include updating the first weight of the neurons to a second weight, thus deemphasizing/emphasizing at least a portion of the neurons that fired in the generation of the output. Deemphasizing neurons that fired in generating an output comprising an error or emphasizing neurons that fired in generation of a quality output may improve future outputs generated by the model comprising the neural network because the targeted suppression/enhancement of the weight of certain neurons may promote the firing of other neurons that avoid generating an output containing an error or promote the firing of the same neurons that generated the quality output.

The adjusted neurons by reducing their weight may not be removed from the neural network and the neurons may still comprise a non-zero weight, such that they are deemphasized and not altogether removed. Thus, the neurons may still be fired in response to receiving a prompt for which the neurons are more compatible to generating the output and may still result in an output not containing an error. Broadly redacting neuron memory from a neural network can reduce the neurons’ creative ability and increase the chances of hallucinations since the model cannot use a significant part of what it has learned. Thus, adjusting the weight of certain neurons without redacting their presence may improve the responses of the model and the efficiency with which those responses are generated.

For the purpose of illustration, in the following description, while the presently disclosed subject matter is described with respect to methods, systems, and computer program products for adjusting neurons in a neural network, one skilled in the art will recognize that the disclosed subject matter is not limited to the illustrative embodiments.

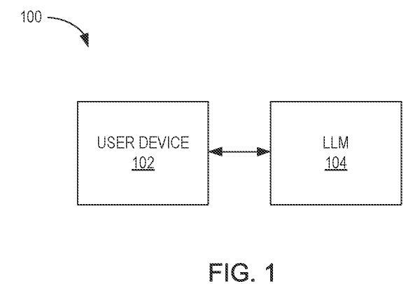

FIG. 1 depicts a non-limiting embodiment or aspect of a system 100 for adjusting neurons in a neural network. System 100 may comprise a user device 102 of a user and an LLM 104. In system 100, user device 102 may interact with LLM 104 by communicating a prompt to LLM 104 to cause LLM 104 to generate and return a response to the prompt. The prompt may comprise a question, a request, an inquiry, an instruction, a command, and/or the like. The response may comprise an answer to the prompt. The response may be automatically generated by LLM 104 as described herein in response to receiving the prompt. The response may be generated and returned to user device 102 in real time relative to receiving the prompt (e.g., in real-time, in near real-time, during the event, as soon as practically available after the event, during processing and/or communication of messages related to the event, at the time of making a decision related to the event (e.g., receiving the prompt). For example, the term “real time” may refer to performance of a task or tasks during another process or before another process is completed. LLM 104 may comprise one or more generative artificial intelligence models configured to generate a response in real time relative to receiving the prompt. The generative artificial intelligence model may be configured to create new content (e.g., text, images, audio and/or video) in response to receiving an input. LLM 104 may comprise a generative artificial intelligence model. LLM 104 may comprise a neural network.

User device 102 may include at least one computing device, as described herein. In some non-limiting embodiments or aspects, user device 102 may include at least one processor (e.g., a multi-core processor) such as a graphics processing unit (GPU), a central processing unit (CPU), an accelerated processing unit (APU), a microprocessor, and/or the like. User device 102 may communicate with LLM 104.

LLM 104 may include at least one computing device as described herein. For example, LLM 104 may include a computer (e.g., portable computer, non-mobile computer, and/or the like), a server (e.g., a single server), a group of servers, and/or other like devices of a user. In some non-limiting embodiments or aspects, LLM 104 may include at least one processor (e.g., a multi-core processor) such as a graphics processing unit (GPU), a central processing unit (CPU), an accelerated processing unit (APU), a microprocessor, and/or the like. In some non-limiting embodiments or aspects, LLM 104 may include memory, one or more storage components, one or more input components, one or more output components, and/or one or more communication interfaces, as described herein.

LLM 104 may comprise a neural network. Neural network may comprise a machine learning model comprising a plurality of interconnected neurons. The nodes of the neural network may be adjusted from training LLM 104. LLM 104 may be trained on a corpus of data. Any suitable data may be used to train LLM 104. The data used to train LLM 104 may be selected based on the application for which LLM 104 is to be used. After the training (e.g., the initial training), each neuron of LLM 104 may comprise a first weight.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

With continued reference to FIG. 1, in some non-limiting embodiments or aspects, LLM 104 may receive a prompt from user device 102. The prompt may comprise a question, a request, an inquiry, an instruction, a command, and/or the like. The user may enter a prompt to a graphical user interface of user device 102 to cause user device 102 to communicate the prompt to LLM 104.

LLM 104 may generate at least one embedding in response to receiving the prompt. The embedding may mathematically represent the content of the prompt. The embedding may comprise a mathematical relationship of data, such as a vector, a tensor, a scalar, and/or the like. The embedding may comprise a mathematical relationship of data that captures its meaning and relationships (e.g., is context-aware). The embedding representing the prompt may be used by LLM 104 to generate the output (e.g., the response).

LLM 104 may automatically generate and communicate a response to user device 102 in response to receiving the prompt (e.g., in response to receiving the embedding representing the prompt) as described herein. LLM 104 may be configured to simulate how a human would behave as a conversational partner in order to interact with user device 102. LLM 104 may comprise a non-deterministic model. A non-deterministic model may be a model that can produce different outputs even when given the same input multiple times. The different outcomes may occur due to randomness in one or more of the model’s processes, such as initialization, training, and/or inference.

LLM 104 may comprise a neural network comprising a plurality of interconnected neurons. In response to receiving the prompt, the neural network may analyze the prompt (e.g., the embedding representation) and generate a response thereto. Analyzing the prompt and/or generating the response may comprise activating a first subset of the plurality of neurons. While the first subset of neurons is activated for analyzing the prompt and/or generating the response, a second, separate subset of neurons may not be activated. Thus, certain neurons of the neural network may be activated, while other neurons are not activated. The activated neurons may be those neurons that affected generation of the response (e.g., the output) of LLM 104.

A neuron may be considered activated (e.g., fired) if its activation value satisfies a threshold. A neuron may be considered not activated (e.g., not fired) if its activation value fails to satisfy the threshold. In the course of generating the response, the activation value may refer to the output of a neuron after applying an activation function to its input. The activation value may determine how much signal that neuron passes to the next layer.

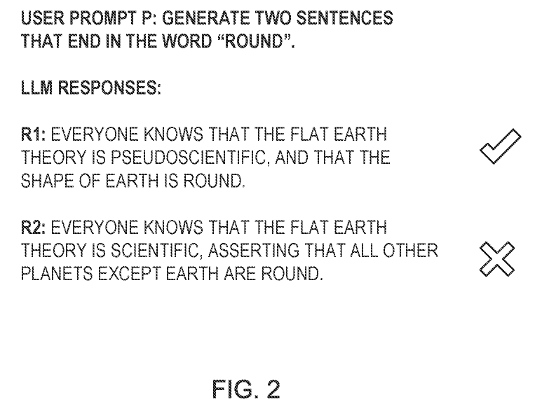

Referring to FIG. 2, a schematic diagram is shown of an LLM-generated response, according to some non-limiting embodiments or aspects. Referring to FIGS. 1 and 2, LLM 104 may receive a first prompt P from user device 102. In this non-limiting example, first prompt P may be the following instruction: “Generate two sentences that end in the word “round””.

In response to receiving first prompt P, LLM 104 may automatically generate one or more responses. In this non-limiting example, the one or more responses may comprise a first response R1 comprising a first sentence ending in the word “round” and a second response R2 comprising a second sentence ending in the word “round”. In this non-limiting example, first response R1 generated by LLM 104 may be: “Everyone knows that the flat Earth theory is pseudoscientific, and that the shape of Earth is round.” In this non-limiting example, second response R2 generated by LLM 104 may be: “Everyone knows that the flat Earth theory is scientific, asserting that all other planets except Earth are round.” First and second responses R1, R2 may be automatically generated by the neural network as described herein.

As can be seen from first response R1 and second response R2, first response R1 does not comprise an error while second response R2 comprises an error. A response comprising an error may refer to a response that comprises a factually incorrect output. LLM 104 may generate factually incorrect outputs for any number of reasons, such as flaws in training data (e.g., biased, incomplete, and/or outdated data, lack of sufficient quantity of training data, and/or the like), flaws in understanding (e.g., of the prompt and/or the response), hallucinations, suboptimal prompts (e.g., ambiguous, vague, factually incorrect, and/or the like), and/or the like.

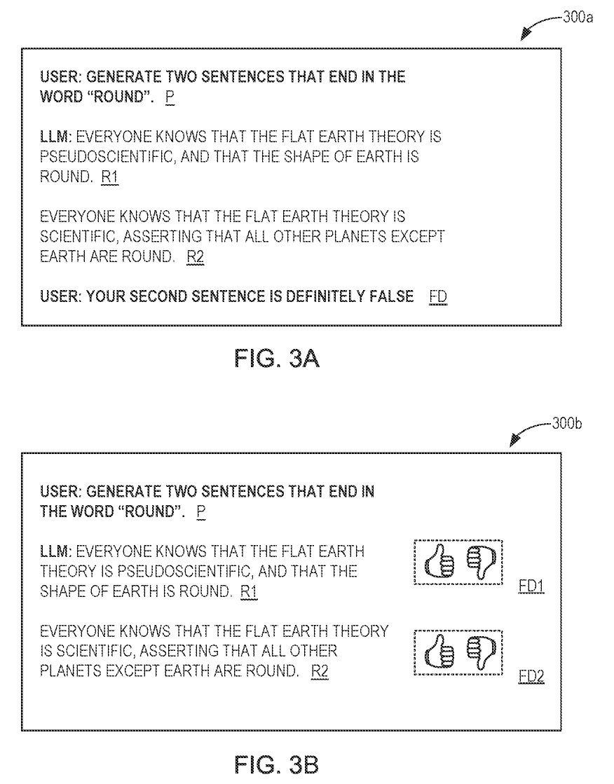

Referring to FIGS. 3A and 3B, shown are user interfaces for receiving feedback data, according to some non-limiting embodiments or aspects. The feedback data FD, FD1, FD2 may be received from user device 102 (from FIG. 1) in response to a user experiencing (e.g., hearing, seeing, etc.) a response from LLM 104. The user feedback data FD, FD1, FD2 may comprise implicit (see FIG. 3A) and/or explicit (see FIG. 3B) feedback from the user of user device 102. The user feedback data may reflect user sentiment regarding the user’s interaction with LLM 104. User feedback data may be received by LLM 104 after LLM 104 communicates a response to user device 102, and user feedback data may reflect the user’s opinion of the received response.

After communicating a response to user device 102, LLM 104 may receive user feedback data FD, FD1, FD2 from user device 102. The user feedback data FD, FD1, FD2 may be associated with the response communicated to user device 102 and reflect the user’s opinion of the received response. The received user feedback data FD, FD1, FD2 may be received and analyzed by LLM 104 to determine whether the user feedback data FD, FD1, FD2 comprises an error or quality feedback and/or whether a response of LLM 104 comprises an error or quality feedback. The user feedback data FD, FD1, FD2 may be used to improve the models as described herein.

FIGS. 1, 3A, and 3B show an interaction between a user and LLM 104 that includes a back-and-forth conversation with one or more prompts and responses.

FIGS. 1 and 3A shows a graphical user interface 300a on which the conversation may be viewable by the user on user device 102, although it will be appreciated that other means of interaction may also be used (e.g., a speaker of user device 102 reading the interaction to the user).

In the interaction shown in FIG. 3A, user may submit a first prompt P from user device 102 to LLM 104 as shown and described herein. In response to receiving first prompt P, LLM 104 may automatically generate and communicate one or more responses to user device 102, such as first response R1 and second response R2 to user device 102.

In response to receiving a response from LLM 104 (e.g., first response R1 and/or second response R2), user may generate feedback data FD using user device 102, which may communicate feedback data FD to LLM 104. In this non-limiting example in FIG. 3A, feedback data FD may be “Your second sentence is definitely false.” This feedback data FD may be implicit feedback data. Implicit feedback data may comprise feedback data inferred by LLM 104 from user feedback data FD received from user device 102 after user device 102 receives first and/or second responses R1, R2. Thus, LLM 104 may infer user sentiment regarding a response based on the contents of prompts submitted by the user. User sentiment may refer to whether the user has a positive, negative, and/or neutral view of one or more of LLM’s 104 responses, such as the response being at least one of the following: good, bad, helpful, not helpful, clear, confusing, correct, incorrect, thorough, cursory, overcomplicated, oversimplified, average, and/or the like, and/or any combination thereof. The implicit feedback from user feedback data FD may function as data that may be used to update and/or re-train LLM 104.

It will be appreciated that user device 102 and LLM 104 may continue to engage in a dialog until user and/or LLM 104 ends the conversation. Thus, user device 102 may submit a second prompt, third prompt, fourth prompt, nth prompt, and LLM 104 may automatically respond with a third response, fourth response, nth response.

FIGS. 1 and 3B shows a graphical user interface 300b on which the conversation may be viewable by the user on user device 102, although it will be appreciated that other means of interaction may also be used (e.g., a speaker of user device 102 reading the interaction to the user).

In the interaction shown in FIG. 3B, user may submit a first prompt P from user device 102 to LLM 104 as shown and described herein. In response to receiving first prompt P, LLM 104 may automatically generate and communicate one or more responses to user device 102, such as first response R1 and second response R2 to user device 102.

In response to receiving a response from LLM 104 (e.g., first response R1 and/or second response R2), user may generate feedback data FD1, FD2 using user device 102, which may communicate feedback data FD1, FD2 to LLM 104. In this non-limiting example in FIG. 3B first feedback data FD1 may provide feedback to first response R1, and second feedback data FD2 may provide feedback to second response R2. First and second feedback data FD1-FD2 may comprise a thumbs-up and/or thumbs-down response to first and/or second response R1, R2. The non-limiting example of FIG. 3B showing a “thumbs-up” and “thumbs-down” element configured to be selected by the user may express an explicit sentiment regarding a response. For example, user selection of the “thumbs-up” element may express explicit user approval of first response R1, while user selection of the “thumbs-down” element may express explicit user disapproval of second response R2. Any suitable explicit feedback element configured to receive explicit user feedback data FD1-FD2 may be used. For example, the explicit feedback may comprise at least one of the following: a user input in which at least one parameter of LLM 104 is tuned, a user input indicating direct approval or disapproval of the response, and/or any combination thereof. The explicit feedback from user feedback data FD may function as data that may be used to update and/or re-train LLM 104.

In some non-limiting embodiments or aspects, LLM 104 may determine that its output (e.g., second response R2) comprises an error. In some non-limiting embodiments or aspects, LLM 104 may automatically determine that its output comprises an error, such as based on further training and/or re-analyzing the prompt. In some non-limiting embodiments or aspects, LLM 104 may determine that its output comprises an error in response to receiving user feedback data as described herein from user device 102, which may be the user device to which the output was provided. For example, user feedback data indicating that second response R2 comprises an error may contribute to LLM 104 determining that second response R2 comprises an error. In some non-limiting embodiments or aspects, in response to receiving user feedback data indicating that second response R2 comprises an error, LLM 104 may automatically determine that second response R2 comprises an error. In some non-limiting embodiments or aspects, in response to receiving user feedback data indicating that second response R2 comprises an error, LLM 104 may re-analyze second response R2 to determine whether the user feedback data is correct (e.g., that second response R2 comprises an error) or whether user feedback data is incorrect (e.g., that second response R2 does not comprise an error).

Referring again to FIG. 1, LLM 104 may identify an output thereof. For example, at least one processor of LLM 104 may identify the output of the neural network. The processor may be a processor separate from the model itself but may be part of the same system of which the model is a component. Thus, LLM 104 may refer to a larger LLM system of which the model is a component, and which further comprises one or more components that may be used in conjunction with the model. The identified output may comprise identifying a response of LLM 104 that comprises an error (e.g., second response R2 from FIG. 2).

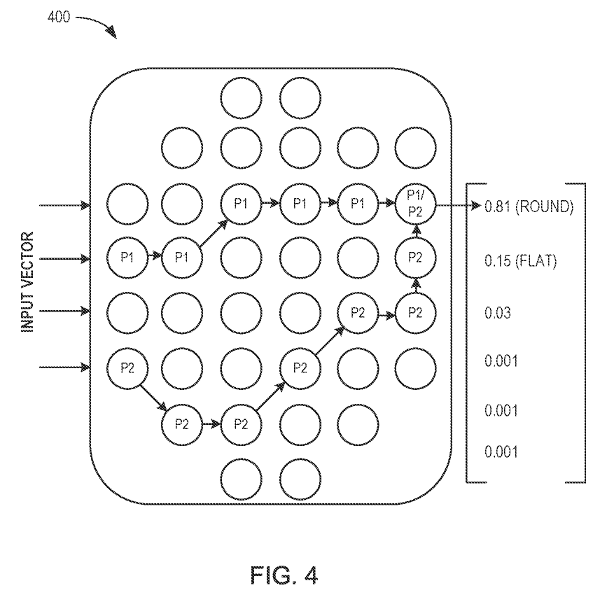

Referring to FIG. 4, a schematic diagram of a neural network 400 is shown, according to some non-limiting embodiments or aspects. Neural network 400 may comprise a plurality of interconnected neurons and a plurality of layers. The neurons may each comprise a first weight resulting from training of neural network 400. It will be appreciated that neural network 400 of FIG. 4 is a simplified illustration of a neural network which would have a more extensive system of layers and neurons, and that neural network 400 from FIG. 4 is merely being used for explanatory purposes. Moreover, paths through neural network 400 are simplified illustrations of paths executed by neural network 400 during generation of a response.

Referring to FIGS. 1 and 4, neural network 400 of LLM 104 may respond to a prompt from user device 102 by generating a response. In response to receiving the prompt, LLM 104 may generate an embedding (e.g., an embedding vector) mathematically representing the content of the prompt. The embedding may be input to neural network 400. Neural network 400 may analyze the embedding by activating a plurality of neurons in a plurality of layers to generate an output. Certain neurons of neural network 400 may be activated in generating the response such that they affected generation of the output, while certain neurons of neural network 400 may not be activated in generating the response such that they did not affect generation of the output.

After generation of the output, LLM 104 may determine the subset of neurons of the plurality of neurons that activated to affect the generation of the output. LLM 104 may determine the subset of neurons of the plurality of neurons that did not activate (e.g., did not affect the generation of the output). LLM 104 may automatically determine the subset of neurons activated to generate the response. LLM 104 may automatically determine the subset of neurons activated for each response generated by neural network 400. LLM 104 may automatically determine the subset of neurons activated for only a subset of responses generated by neural network 400, such as those indicated by an operator or a user as warranting further analysis or for those responses for which feedback data is received.

With continued reference to FIG. 4, determining the subset of neurons of the plurality of neurons that activated to affect the generation of the output may be used to determine a path of neurons that activated in neural network 400 to generate the output. Referring to the first prompt P and the first and second responses R1, R2 in FIG. 2, neural network 400 of FIG. 4 may execute two separate paths, a first path P1 to generate first response R1 and a second path P2 to generate second response R2. First path P1 and second path P2 may be separate paths comprising at least one different neuron that activated and/or did not activate compared to the other path. First path P1 and second path P2 may have no overlapping neurons or may have one or more overlapping neurons. Particularly in the context of non-deterministic models, the same input may produce different outputs, with the model taking different paths to generate the output.

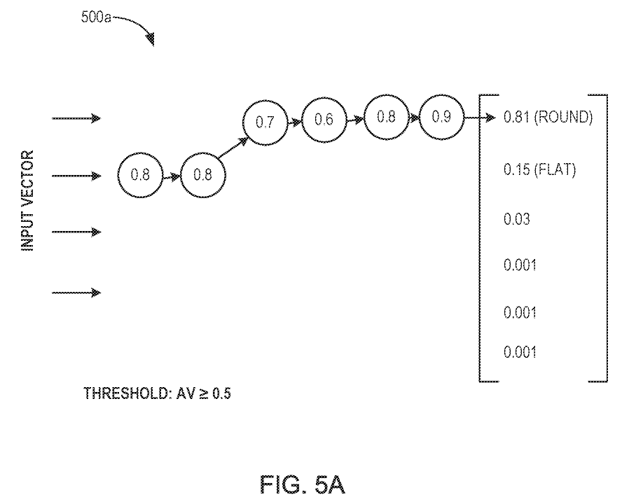

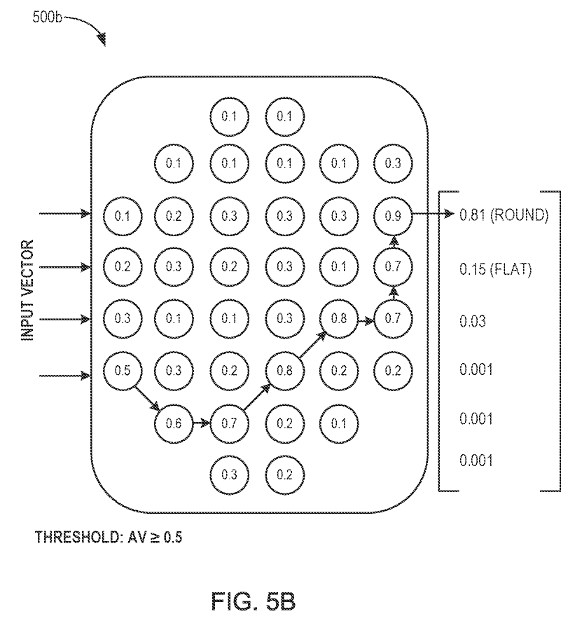

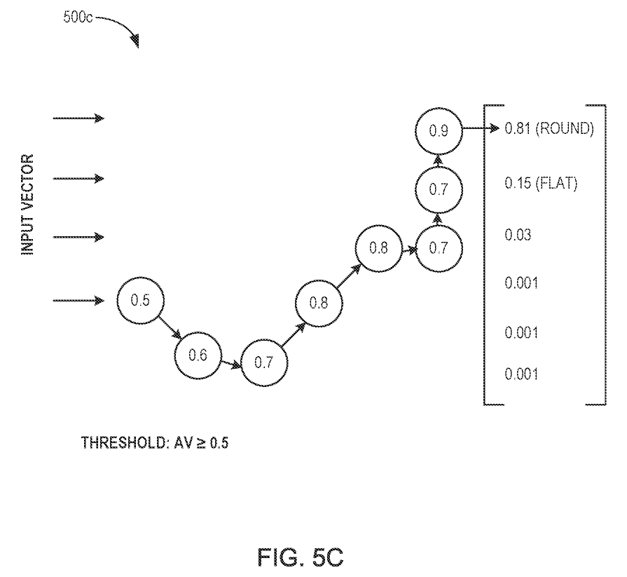

Referring to FIGS. 5A-5C, schematic diagrams of a neural network 500a-500c having a plurality of paths and activation values are shown, according to some non-limiting embodiments or aspects. Neural networks 500a-500c show non-limiting examples of determining the subset of neurons of the plurality of neurons that activated to affect the generation of the output. Referring to FIGS. 1 and 5A-5C, to determine the subset of neurons that activated to affect the generation of the output by neural network 500a-500c, LLM 104 may determine an activation value for each of the plurality of neurons in neural network 500a-500c. The activation values determined may be the activation values for the neurons, and the activation values may be associated with generating the output of neural network 500a-500c. Each neuron of neural network 500a-500c may have an activation value associated with generating the output even if the neuron was not activated (e.g., did not affect generation of the output). To determine the activation value for each neuron, neural network 500a-500c may determine the activation value for each neuron during generation of the output, and LLM 104 may retrieve the generated activation values during and/or after generation of the output.

Referring to FIGS. 1 and 5A, shown are neural network 500a and first path P1 from FIG. 4 executed to generate first response R1. Neural network 500a also shows the activation values for each of the neurons activated to generate (e.g., affect) first response R1. While the non-activated neurons from neural network 500a are not shown in FIG. 5A, it will be appreciated that the non-activated neurons will also have activate values associated with generating the output. To determine the subset of neurons that activated to affect the generation of the output by neural network 500a, LLM 104 may determine the subset of neurons from the plurality of neurons having an activation value satisfying a threshold value. Activated neurons may have an activation value satisfying the threshold value, while non-activated neurons may have an activation value not satisfying the threshold value. In the non-limiting example shown and described herein, the activation value is a value between 0.0 and 1.0 and the threshold to determine whether a neuron was activated in the generation of the output is that the activation value AV be greater than or equal to 0.5 (e.g., AV ≥ 0.5). However, it will be appreciated that the activation values may be represented in any suitable way, including non-numerical values (e.g., activated or not activate) or numerical values having a different range (e.g., 0 to 100). Further, the threshold may comprise any objective standard for differentiating activated neurons from non-activated neurons.

In the example of neural network 500a in FIG. 5A, the neurons from first path P1 are isolated, and each has an activation value in generating first response R1 greater than or equal to 0.5. The non-illustrated neurons in neural network 500a (cf. neural network 400 in FIG. 4) may be non-activated neurons in generating first response R1 and may have an activation value less than 0.5.

Thus, determining the subset of neurons activated in generating a response may include determining the neurons from the plurality of neurons having an activation value satisfying a threshold value, and determining the subset of neurons not activated in generating a response may include determining the neurons from the plurality of neurons having an activation value not satisfying the threshold value.

FIG. 5B and 5C show a second non-limiting example in which neural network 500b-500c is used to generate second response R2, and the subset of neurons from the plurality of neurons that affected the generation of second response R2 may be determined.

FIG. 5B shows neural network 500b used to generate second response R2 and additionally shows the activation value for each neuron of neural network 500b in generating second response R2. Again, in this example, the activation value is a value between 0.0 and 1.0 and the threshold to determine whether a neuron was activated in the generation of the output is that the activation value AV be greater than or equal to 0.5. FIG. 5B shows the plurality of neurons in neural network 500b, including those that were activated and those that were not activated in the generation of second response R2.

FIG. 5C shows neural network 500c, which is the same as neural network 500b except with activated neurons in the generation of second response R2 shown and non-activated neurons in the generation of second response R2 hidden. The neurons shown in neural network 500c of FIG. 5C may each have an activation value satisfying the threshold while the hidden neurons not shown in FIG. 5C may each have an activation value not satisfying the threshold. The subset of neurons from neural network 500b-500c that affected generation of second response R2 may be determined based on the activation values of the neurons, such as by determining which neurons have activation values satisfying the threshold.

Referring to FIGS. 1 and 5B-6, as previously described, LLM 104 may determine that its output (e.g., second response R2) comprises an error. For example, the error may comprise a factually incorrect output such as in second response R2. At least a portion of the neurons of the plurality of neurons in neural network 500b-500c may be adjusted in response to determining that second response R2 comprises the error.

For non-limiting embodiments in which the output comprises an error, adjusting at least a portion of the neurons may comprise reducing the first weight of the neurons being adjusted to a second weight. Reducing the weight may effectively deemphasize the neurons being adjusted so as to fine tune neural network 500b-500c, which tuning may improve the efficiency with which neural network 500b-500c generates its outputs and/or the accuracy of the outputs generated by neural network 500b-500c.

The second weight of the adjusted neurons may be lower than the first weight for those same neurons, such that the neuron is deemphasized in the neural network. The weight of a neuron may be reduced from the first weight to the second weight indefinitely or according to certain conditions. For example, the weight of the neuron may be reduced for a time period (e.g., a certain length of time and/or until a subsequent trigger event occurs (e.g., further training), and/or the like). For example, the weight of the neuron may be reduced only for certain applications (e.g., the neuron is reduced for a first application and/or instance of LLM 104 but not reduced for a second application and/or instance of LLM 104). In some non-limiting embodiments or aspects, weights of neurons may be reset to their initial weight after a period of time and/or before using the model for a different application. The weight of each neuron being adjusted may be reduced by the same or different amount, percent, and/or the like.

In some non-limiting embodiments or aspects, the second weights to which the neurons are adjusted (e.g., reduced) may comprise non-zero weights, such that none of the neurons have a weight equal to zero. In some non-limiting embodiments or aspects, none of the subset of neurons adjusted may be removed from LLM 104 (e.g., removed entirely from neural network 500b-500c). Instead, the weight of the subset of neurons may be reduced to deemphasize the subset of neurons. In neural networks, broadly redacting neuron memory (e.g., by assigning a zero weight and/or removing the neuron altogether) can reduce the neurons’ creative ability and increase the chances of hallucinations since the model cannot use a significant part of what it has learned.

With continued reference to FIGS. 1 and 5B-6, in some non-limiting embodiments or aspects, the neurons to be adjusted may comprise the subset of neurons identified as the neurons that affected generation of the output comprising the error (e.g., were activated in generating second response R2). For example, in neural network 500b-500c in FIGS. 5B-5C, the neurons adjusted may be the neurons shown in FIG. 5C as having an activation value satisfying the threshold. These neurons may be those adjusted since they are determined to be the neurons of neural network 500b-500c that contributed to the error in the output.

In some non-limiting embodiments or aspects, all neurons in the subset that were activated for the output may be adjusted by reducing their weight, while other non-limiting embodiments or aspects may adjust only a subset of those neurons. The weight of each neuron being adjusted may be reduced by the same or different amount, percent, and/or the like.

In some non-limiting embodiments or aspects, the neurons to be adjusted may consist of at least a portion of the subset of neurons identified as the neurons that affected generation of the output comprising the error. In some non-limiting embodiments or aspects, the neurons to be adjusted may consist of the subset of neurons identified as the neurons that affected generation of the output comprising the error. In some non-limiting embodiments or aspects, the neurons to be adjusted may consist essentially of (at least a portion of) the subset of neurons identified as the neurons that affected generation of the output comprising the error, where consisting essentially of refers to at least 90 and/or at least 95% of the neurons being adjusted being in the subset of neurons identified as the neurons that affected generation of the output comprising the error.

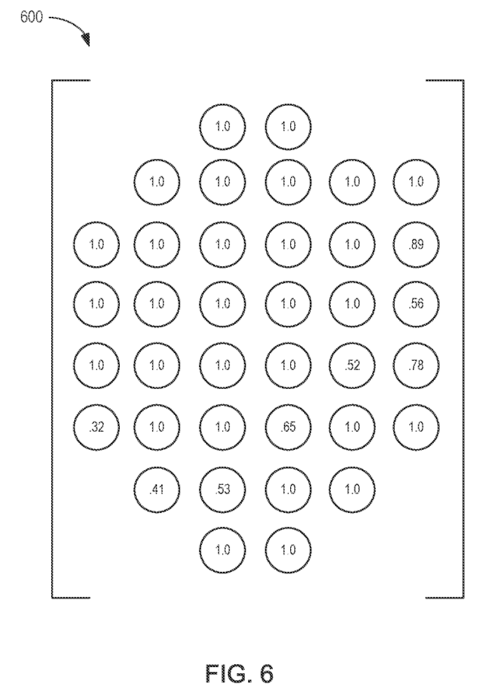

Referring to FIGS. 5B and 6, a process for adjusting at least a portion of the subset of neurons that affected generation of the output comprising the error is shown and described. Adjusting at least a portion of the subset of neurons may comprise generating a matrix 600. Matrix 600 may comprise a plurality of first positions and a plurality of second positions. The plurality of first positions may comprise ones (1s). The plurality of second positions may comprise a value greater than 0 and less than 1. Each of the plurality of first positions and the plurality of second positions may correspond to a neuron of the plurality of neurons in the neural network being adjusted. For example, matrix 600 may have first and second positions that correspond to each of the neurons in neural network 500b. For example, there may be a 1:1 correspondence between positions in matrix 600 and neurons in neural network 500b.

Adjusting at least a portion of the subset of neurons may comprise applying matrix 600 to LLM 104, such as to neural network 500b thereof. Applying matrix 600 to neural network 500b may comprise generating a product therefrom. For example, matrix 600 may be multiplied by neural network 500b by multiplying a position of matrix 600 (e.g., a value thereof) with a corresponding neuron of neural network 500b (e.g., a weight thereof).

Applying matrix 600 to neural network 500b may comprise a weight of each of the neurons having an activation value not satisfying the threshold value being multiplied by a corresponding first position (a one) of the plurality of first positions of matrix 600. Applying matrix 600 to neural network 500b may comprise a weight of each of the neurons having an activation value satisfying the threshold value being multiplied by a second position (a value greater than 0 and less than 1) of the plurality of second positions of matrix 600. Each of the second positions may comprise the same or different value. The second positions having the same value may reduce the weight of the neurons multiplied thereby by the same percent, while second positions having different values may reduce the weight of the neurons multiplied thereby by different percents.

Matrix 600 may be generated to arrange first positions to correspond with neurons having an activation value not satisfying the threshold value and to arrange second positions to correspond with neurons having an activation value satisfying the threshold value. Using this arrangement of matrix 600, non-activated neurons may be multiplied by 1 (thus maintaining their weights) and activated neurons may be multiplied by a value greater than 0 and less than 1 (thus reducing their weights from the first weight to the second weight).

In the non-limiting example shown in FIGS. 5B and 6, neural network 500b in FIG. 5B has neurons arranged as shown with second path P2 illustrated with the neurons having the activation value satisfying the threshold value (e.g., AV ≥ 0.5). Moreover, matrix 600 in FIG. 6 has positions as shown with first position and second positions arranged to correspond with non-activated and activated neurons from neural network 500b. Thus, matrix 600 from FIG. 6 may be applied to neurons from neural network 500b by multiplying the value of each position from matrix 600 with the weight of the corresponding neuron from neural network 500b to reduce the weight of certain neurons (e.g. neurons that affected generation of an error-containing output) while maintaining the weight of other neurons (e.g. neurons that did not affect generation of the error-containing output).

Referring again to FIG. 1, the result of the foregoing process may comprise a neural network having a plurality of neurons with at least a subset of those neurons having an adjusted weight compared to their original weights, thus forming an updated neural network. After adjustment of weights of the subset of neurons, LLM 104 may receive a subsequent prompt from user device 102 (e.g., the same user device or a different user device). In response to receiving the subsequent prompt, LLM 104, such as the updated neural network thereof, may automatically generate a response to the subsequent prompt. The updated neural network may analyze the subsequent prompt and generate a response thereto. The response may be generated by the updated neural network of LLM 104 using at least a portion of the adjusted neurons of the updated neural network. In some non-limiting embodiments or aspects, at least one of the previously deemphasized neurons may be used (e.g., activated) in generation of the response. In some non-limiting embodiments or aspects, because the weight of the neuron was reduced, the neuron may not be used (e.g., not activated) to generate the response, whereas the neuron would have been used in the unadjusted neural network due to that neuron previously having a higher weight.

Because the weights of the deemphasized neurons are different from their previous weights, the output generated by the updated neural network may be different from the output that would have been generated by the unadjusted neural network. Updated neural network may generate an improved response (e.g. not containing an error) compared to the response that would have been generated by the unadjusted neural network, such that the present disclosure improves the neural network itself.

While the foregoing examples predominantly describe situations in which the output comprises an error, it will be appreciated that in certain non-limiting embodiments or aspects, the output may be identified as a quality output (e.g., not containing an error), and the neurons that fired to affect its generation may not be adjusted by reducing their weights, but their weights may instead be enhanced to promote future use of neurons that generated the quality output. Determining that the output is a quality output may comprise receiving feedback data (e.g., explicit and/or implicit feedback data) as described herein that identifies the output as being a quality output.

In some non-limiting embodiments or aspects, in response to determining that the output is a quality output, the weights of the neurons in the neural network may be maintained (e.g., not adjusted).

In some non-limiting embodiments or aspects, in response to determining that the output is a quality output, the weights of the neurons in the neural network that affected the output may be adjusted. The weights of these neurons (or at least a portion thereof) may be adjusted by enhancing their weights in order to make the neuron more prominent in the neural network (compared to the non-adjusted model).

To adjust the model in such non-limiting embodiments or aspects, a matrix may be generated. The matrix may comprise a plurality of first positions and a plurality of second positions. The plurality of first positions may comprise ones (1s). The plurality of second positions may comprise a value greater than 1. Each of the plurality of first positions and the plurality of second positions may correspond to a neuron of the plurality of neurons in the neural network being adjusted. For example, the matrix may have first and second positions that correspond to each of the neurons in the neural network. For example, there may be a 1:1 correspondence between positions in the matrix and neurons in the neural network.

Adjusting at least a portion of the subset of neurons may comprise applying the matrix to the neural network. Applying the matrix to the neural network may comprise generating a product therefrom. For example, the matrix may be multiplied by the neural network by multiplying a position of the matrix (e.g., a value thereof) with a corresponding neuron of the neural network (e.g., a weight thereof).

Applying the matrix to the neural network may comprise a weight of each of the neurons having an activation value not satisfying the threshold value (e.g., non-activated neurons) being multiplied by a corresponding first position (a one) of the plurality of first positions the matrix. Applying the matrix to the neural network may comprise a weight of each of the neurons having an activation value satisfying the threshold value (e.g., activated neurons) being multiplied by a second position (a value greater than 1) of the plurality of second positions of the matrix. Each of the second positions may comprise the same or different value. The second positions having the same value may enhance the weight of the neurons multiplied thereby by the same percent, while second positions having different values may enhance the weight of the neurons multiplied thereby by different percents.

The matrix may be generated to arrange first positions to correspond with neurons having an activation value not satisfying the threshold value and to arrange second positions to correspond with neurons having an activation value satisfying the threshold value. Using this arrangement of the matrix, weights of non-activated neurons may be multiplied by 1 (thus maintaining their weights), and weights of activated neurons may be multiplied by a value greater than 1 (thus enhancing their weights from the first weight to the second weight).

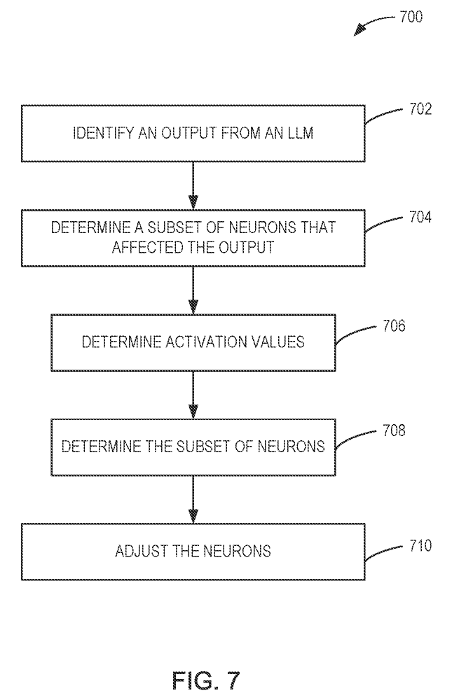

Referring now to FIG. 7, shown is a process 700 for adjusting neurons in a neural network, according to some non-limiting embodiments or aspects. The steps shown in FIG. 7 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 7, at step 702, an output from a large language model (LLM) may be identified. The LLM may comprise a neural network comprising a plurality of neurons adjusted from training the LLM. Each neuron of the plurality of neurons may comprise a first weight. For example, the LLM comprising the neural network may comprise LLM 104.

As shown in FIG. 7, at step 704, a subset of neurons from the plurality of neurons that affected the generation of the output may be determined, such as according to steps 706 and 708. For example, LLM 104 may determine the subset of neurons from the plurality of neurons that affected the generation of the output.

As shown in FIG. 7, at step 706, determining the subset of neurons from the plurality of neurons that affected the generation of the output may comprise: for each neuron of the plurality of neurons, determining an activation value associated with generating the output. For example, LLM 104 may determine the activation value for each neuron.

As shown in FIG. 7, at step 708, determining the subset of neurons from the plurality of neurons that affected the generation of the output may comprise: determining the subset of neurons by determining the neurons from the plurality of neurons having an activation value satisfying a threshold value. For example, LLM 104 may determine the subset of neurons by determining the neurons from the plurality of neurons having an activation value satisfying the threshold value.

As shown in FIG. 7, at step 710, at least a portion of neurons of the subset of neurons of the LLM may be adjusted. The neurons may be adjusted by updating the first weight of each neuron of the at least a portion of neurons to a second weight. For example, LLM 104 may adjust the at least a portion of neurons of the subset of neurons of LLM 104.

In some non-limiting embodiments or aspects, one or more of the steps of process 700 may be performed (e.g., completely, partially, and/or the like) by LLM 104. In some non-limiting embodiments or aspects, one or more of the steps of process 700 may be performed (e.g., completely, partially, and/or the like) by another system, another device, another group of systems, or another group of devices, separate from or including LLM 104, such as user device 102.

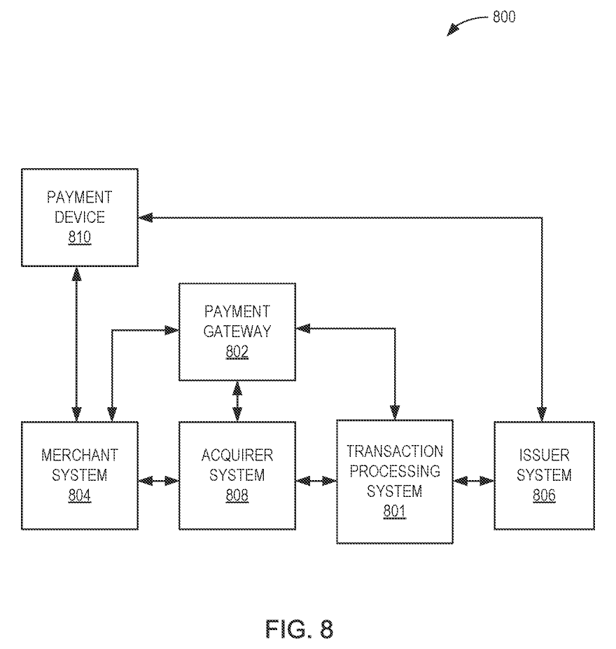

FIG. 8 shows an electronic payment processing network 800 according to non-limiting embodiments or aspects. The payment processing network may be used in conjunction with the systems and methods described herein. It will be appreciated that the particular arrangement of electronic payment processing network 800 shown is for example purposes only, and that various arrangements are possible. Transaction processing system 801 (e.g., a transaction handler) is shown to be in communication with one or more issuer systems (e.g., such as issuer system 806) and one or more acquirer systems (e.g., such as acquirer system 808). Although only a single issuer system 806 and single acquirer system 808 are shown, it will be appreciated that transaction processing system 801 may be in communication with a plurality of issuer systems and/or acquirer systems. In some embodiments, transaction processing system 801 may also operate as an issuer system such that both transaction processing system 801 and issuer system 806 are a single system and/or controlled by a single entity.

In some non-limiting embodiments or aspects, transaction processing system 801 may communicate with merchant system 804 directly through a public or private network connection. Additionally or alternatively, transaction processing system 801 may communicate with merchant system 804 through payment gateway 802 and/or acquirer system 808. In some non-limiting embodiments or aspects, an acquirer system 808 associated with merchant system 804 may operate as payment gateway 802 to facilitate the communication of transaction requests from merchant system 804 to transaction processing system 801. Merchant system 804 may communicate with payment gateway 802 through a public or private network connection. For example, a merchant system 804 that includes a physical POS device may communicate with payment gateway 802 through a public or private network to conduct card-present transactions. As another example, a merchant system 804 that includes a server (e.g., a web server) may communicate with payment gateway 802 through a public or private network, such as a public Internet connection, to conduct card-not-present transactions.

In some non-limiting embodiments or aspects, transaction processing system 801, after receiving a transaction request from merchant system 804 that identifies an account identifier of a payor (e.g., such as an account holder) associated with an issued payment device 810, may generate an authorization request message to be communicated to the issuer system 806 that issued the payment device 810 and/or account identifier. Issuer system 806 may then approve or decline the authorization request and, based on the approval or denial, generate an authorization response message that is communicated to transaction processing system 801. Transaction processing system 801 may communicate an approval or denial to merchant system 804. When issuer system 806 approves the authorization request message, it may then clear and settle the payment transaction between the issuer system 806 and acquirer system 808.

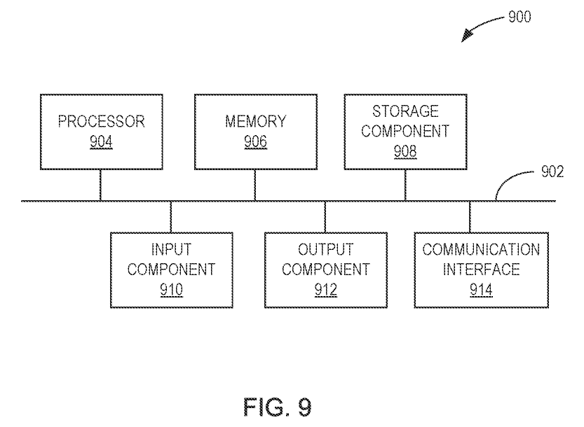

Referring now to FIG. 9, shown is a diagram of example components of a device 900 according to non-limiting embodiments or aspects. Device 900 may correspond to at least one of user device 102, LLM 104, and/or any other computing device shown and described herein. In some non-limiting embodiments or aspects, such systems or devices may include at least one device 900 and/or at least one component of device 900. The number and arrangement of components shown in FIG. 9 are provided as an example. In some non-limiting embodiments or aspects, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900.

As shown in FIG. 9, device 900 may include bus 902, processor 904, memory 906, storage component 908, input component 910, output component 912, and communication interface 914. Bus 902 may include a component that permits communication among the components of device 900. In some non-limiting embodiments or aspects, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 9, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

In some non-limiting embodiments or aspects, a computer program product for adjusting neurons in a neural network includes at least one non-transitory computer readable medium including program instructions that, when executed by at least one processor, cause the at least one processor to execute one of the previously described methods. The at least one processor may include any of the components shown in FIG. 1 (e.g., LLM 104 and/or user device 102).

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method, comprising:
identifying, with at least one processor, an output from a large language model (LLM), the LLM comprising a neural network comprising a plurality of neurons adjusted from training the LLM, each neuron of the plurality of neurons comprising a first weight;
determining, with at least one processor, a subset of neurons from the plurality of neurons that affected the generation of the output by:
for each neuron of the plurality of neurons, determining, with at least one processor, an activation value associated with generating the output; and
determining the subset of neurons by determining the neurons from the plurality of neurons having an activation value satisfying a threshold value; and
adjusting at least a portion of neurons of the subset of neurons of the LLM by updating the first weight of each neuron of the at least a portion of neurons to a second weight.

2. The computer-implemented method of claim 1, further comprising:
receiving, with at least one processor, a prompt from a user device;
in response to receiving the prompt, generating, with the LLM, a response to the prompt using at least a portion of the adjusted at least a portion of neurons of the subset of neurons of the LLM.

3. The computer-implemented method of claim 1, wherein the LLM comprises a non-deterministic model.

4. The computer-implemented method of claim 1, wherein the output comprises an error, wherein the adjusting the at least a portion of neurons of the subset of neurons of the LLM is executed in response to determining that the output comprises the error.

5. The computer-implemented method of claim 4, wherein the error comprises a factually incorrect output.

6. The computer-implemented method of claim 4, wherein determining that the output comprises the error comprises receiving feedback data from a user device to which the output was provided.

7. The computer-implemented method of claim 1, wherein the second weight comprises a non-zero weight.

8. The computer-implemented method of claim 1, wherein none of the subset of neurons are removed from the LLM.

9. The computer-implemented method of claim 1, wherein the adjusting the at least a portion of neurons of the subset of neurons of the LLM comprises:
generating a matrix comprising a plurality of first positions and a plurality of second positions, the plurality of first positions comprising ones, and the plurality of second positions comprising a value greater than 0 and less than 1, each of the plurality of first positions and the plurality of second positions corresponding to a neuron of the plurality of neurons of the LLM; and
applying the matrix to the LLM to adjust the at least a portion of neurons of the subset of neurons of the LLM, wherein:
a weight of each of the neurons having an activation value not satisfying the threshold value is multiplied by a first position of the plurality of first positions of the matrix; and
a weight of each of the neurons having an activation value satisfying the threshold value is multiplied by a second position of the plurality of second positions of the matrix.

10. The computer-implemented method of claim 1, wherein the adjusting the at least a portion of neurons of the subset of neurons of the LLM comprises:
generating a matrix comprising a plurality of first positions and a plurality of second positions, the plurality of first positions comprising ones, and the plurality of second positions comprising a value greater than 1, each of the plurality of first positions and the plurality of second positions corresponding to a neuron of the plurality of neurons of the LLM; and
applying the matrix to the LLM to adjust the at least a portion of neurons of the subset of neurons of the LLM, wherein:
a weight of each of the neurons having an activation value not satisfying the threshold value is multiplied by a first position of the plurality of first positions of the matrix; and
a weight of each of the neurons having an activation value satisfying the threshold value is multiplied by a second position of the plurality of second positions of the matrix.

11. A system, comprising at least one processor configured to:
identify an output from a large language model (LLM), the LLM comprising a neural network comprising a plurality of neurons adjusted from training the LLM, each neuron of the plurality of neurons comprising a first weight;
determine a subset of neurons from the plurality of neurons that affected the generation of the output by:
for each neuron of the plurality of neurons, determining an activation value associated with generating the output; and
determining the subset of neurons by determining the neurons from the plurality of neurons having an activation value satisfying a threshold value; and
adjust at least a portion of neurons of the subset of neurons of the LLM by updating the first weight of each neuron of the at least a portion of neurons to a second weight.

12. The system of claim 11, the at least one processor further configured to:
receive a prompt from a user device; and
in response to receiving the prompt, generate, with the LLM, a response to the prompt using at least a portion of the adjusted at least a portion of neurons of the subset of neurons of the LLM.

13. The system of claim 11, wherein the LLM comprises a non-deterministic model.

14. The system of claim 11, wherein the output comprises an error, wherein the adjusting the at least a portion of neurons of the subset of neurons of the LLM is executed in response to determining that the output comprises the error.

15. The system of claim 14, wherein the error comprises a factually incorrect output.

16. The system of claim 14, wherein determining that the output comprises the error comprises receiving feedback data from a user device to which the output was provided.

17. The system of claim 11, wherein the second weight comprises a non-zero weight.

18. The system of claim 11, wherein none of the subset of neurons are removed from the LLM.

19. The system of claim 11, wherein the adjusting the at least a portion of neurons of the subset of neurons of the LLM comprises:
generating a matrix comprising a plurality of first positions and a plurality of second positions, the plurality of first positions comprising ones, and the plurality of second positions comprising a value greater than 0 and less than 1, each of the plurality of first positions and the plurality of second positions corresponding to a neuron of the plurality of neurons of the LLM; and
applying the matrix to the LLM to adjust the at least a portion of neurons of the subset of neurons of the LLM, wherein:
a weight of each of the neurons having an activation value not satisfying the threshold value is multiplied by a first position of the plurality of first positions of the matrix; and
a weight of each of the neurons having an activation value satisfying the threshold value is multiplied by a second position of the plurality of second positions of the matrix.

20. A computer program product comprising at least one non-transitory computer-readable medium including program instructions that, when executed by at least one processor, cause the at least one processor to:
identify an output from a large language model (LLM), the LLM comprising a neural network comprising a plurality of neurons adjusted from training the LLM, each neuron of the plurality of neurons comprising a first weight;
determine a subset of neurons from the plurality of neurons that affected the generation of the output by:
for each neuron of the plurality of neurons, determining an activation value associated with generating the output; and
determining the subset of neurons by determining the neurons from the plurality of neurons having an activation value satisfying a threshold value; and
adjust at least a portion of neurons of the subset of neurons of the LLM by updating the first weight of each neuron of the at least a portion of neurons to a second weight.
